(19) United States
(12) Patent Application Publication
(10) Pub. No.: US 2024/0404177 A1
(43) Pub. Date: Dec. 5, 2024

(54) PORTAL CONTENT FOR COMMUNICATION SESSIONS

(71) Applicant: Apple Inc., Cupertino, CA (US)

(72) Inventors: Alexandre Da Veiga, San Francisco, CA (US); Wei Wang, Santa Clara, CA (US); Jeffrey S Norris, Saratoga, CA (US)

(21) Appl. No.: 18/679,649

(22) Filed: May 31, 2024

Related U.S. Application Data
(60) Provisional application No. 63/470,907, filed on Jun. 4, 2023.

(51) Int. Cl. G06T 15/20; G06T 19/00

(52) U.S. Cl. CPC G06T 15/20; G06T 19/006; G06T 2200/04

(57) ABSTRACT

Devices, systems, and methods that provide a view of a three-dimensional (3D) environment (e.g., a viewer's room) with a portal providing views of another user's (e.g., a sender's) background environment during a communication session. For example, a process at a first electronic device may include presenting a view of a first 3D environment. Data representing a second 3D environment based at least in part on sensor data captured in a physical environment of a second electronic device may be obtained. Portal content based on the data representing the second 3D environment and a viewpoint within the first 3D environment may be determined. A portal with the portal content may be displayed in the view of the first 3D environment, where the portal content depicts a portion of the second 3D environment viewed through the portal from the viewpoint.

### CROSS-REFERENCE TO RELATED APPLICATIONS

This application claims the benefit of U.S. Provisional Application Ser. No. 63/470,907 filed Jun. 4, 2023, which is incorporated herein in its entirety.

### TECHNICAL FIELD

The present disclosure generally relates to electronic devices that use sensors to provide views during communication sessions, including views that include representations of one or more of the environments of the electronic devices participating in the sessions.

### BACKGROUND

Various techniques are used to present communication sessions such as video conferences, interactive gaming sessions, and other interactive social experiences. For example, the participants may see realistic or unrealistic representations of the users (e.g., avatars) participating in the sessions. However, there is a need to provide a representation of at least a portion of a sender's environment (e.g., background) to give some context of where the sender is calling from.

### SUMMARY

Various implementations disclosed herein include devices, systems, and methods that provide a view of a three-dimensional (3D) environment (e.g., a viewer's room) with a portal providing views of a representation of another user's environment (e.g., a sender's room) and a representation of the user (e.g., an avatar). Rather than providing fully immersive views, the representation may be displayed at a relatively small viewing portal at a fixed position within a larger 3D environment (e.g., a portal). Providing at least a portion of a representation of a sender's background within a portal may be intended to give some context of where the sender is calling from. However, head mounted devices (HMDs) may be limited in updating a view of a user and a user's background because external facing camera's may not be able to capture the background environment during communication session from the perspective of a typical video chat session (e.g., having the camera positioned at 1 to 2 meters in front of the user to capture both the user and the live background data). Thus, when both users are wearing HMDs during a communication session, if there is a desire to provide the actual (“live”) background, or at least a representation of the background during the session, then the system may utilize previously captured images of the environment, or at least a portion of the environment before the communication session, or the system may hallucinate any gaps. Then based on a sender's position with respect to the background, and/or a viewer's viewpoint position, the background may be displayed and updated accordingly.

In some implementations, the background data may be provided by the sender's device capturing sensor data of his or her environment, potentially filling in data gaps (e.g., hallucinating content), and may be provided to the viewer's device using parameters (e.g., blurring, not depicting other people, providing a limited (e.g., 180° FOV), using updating criteria based on changes/new content, etc.). The processing of the background data to determine the portal content (e.g., blurring, not depicting other people, providing a limited (e.g., 180° FOV), using updating criteria based on changes/new content, etc.) may be performed at the sender's device, the viewer's device, or a combination thereof. For example, the sender's device may limit the amount of portal content sent to the viewer's device such that the content may be blurred or may provide a limited view of the background.

In some implementations, the portal may provide multi-directional views (e.g., viewpoint dependent) of the other environment that changes as the viewer moves relative to the portal. The portal may present a portal view of received 180° stereo image/video background content on a plane/surface displayed in a 3D space (e.g., VR or MR). In some implementations, during capture of the sender's background, the sender's device may update a low frequency screenshot (RGB image), provide a current depth map, and optionally include additional metadata such as head orientation/pose. The sender's device and/or the viewer's device may be able to fill gaps/holes in the background (e.g., occlusions during a room scan, portions of the room were not scanned, etc.), and periodically provide updates to the viewer. For example, as the sender moves about his or her environment and provides additional views for the sender's electronic device to capture additional sensor data, the background data may be updated for the portal content.

In some implementations, specific features of the portal content may be limited in the amount of data provided, e.g., providing a viewpoint dependent view, privacy features to blur portions of the background, masking out people or other motion objects in the background, and the like. Thus, user privacy may be preserved by only providing some of the user background information, e.g., blurring portions of, or all of, the background environment, not depicting other people or other objects in the background, providing a limited view (e.g., 180° FOV), using updating criteria based on changes and/or new content in the background environment, and the like.

In general, one innovative aspect of the subject matter described in this specification can be embodied in methods, at a first electronic device including one or more processors, that include the actions of presenting a view of a first 3D environment, obtaining data representing a second 3D environment, the data representing the second 3D environment based at least in part on sensor data captured in a physical environment of a second electronic device, determining portal content based on the data representing the second 3D environment and a viewpoint within the first 3D environment, and displaying, in the view of the first 3D environment, a portal with the portal content, wherein the portal content depicts a portion of the second 3D environment viewed through the portal from the viewpoint.

These and other embodiments can each optionally include one or more of the following features.

In some aspects, the portal content is based on synthesizing data representing a portion of the second 3D environment not represented in sensor data captured in the physical environment of the second electronic device.

In some aspects, the portal content is updated based on detecting a change in the second 3D environment or in the physical environment of the second electronic device.

In some aspects, obtaining the data representing the second 3D environment includes obtaining a parameter associated with the data representing the second 3D environment.

In some aspects, the parameter identifies a field of view or an orientation of the second 3D environment, and wherein determining portal content is further based on the parameter.

In some aspects, determining portal content includes blurring some of the portion of the second 3D environment based on the identified field of view or the orientation of the second 3D environment.

In some aspects, the method further includes the actions of obtaining data representing a user of the second electronic device, wherein determining the portal content is further based on the data representing the user of the second electronic device, and wherein the portal content depicts the representation of the user of the second electronic device in front of the portion of the second 3D environment. In some aspects, determining portal content includes blurring the portion of the second 3D environment behind the representation of the user of the second electronic device. In some aspects, the data representing the second 3D environment depicts less than a 360-degree view of the second 3D environment. In some aspects, the data representing the second 3D environment depicts a 360-degree view of the second 3D environment.

In some aspects, the method further includes the actions of determining a position at which to display the portal within the view of the first 3D environment based on the viewpoint. In some aspects, the method further includes the actions of changing the portal content based on changes to the viewpoint within the first 3D environment.

In some aspects, displaying, in the view of the first 3D environment, the portal with the portal content is based on determining a positional relationship of the viewpoint relative to the portal. In some aspects, a position of the portal within the first 3D environment is constant as the viewpoint changes within the first 3D environment. In some aspects, a position of the portal within the first 3D environment changes based on changes to the viewpoint within the first 3D environment.

In some aspects, the data representing the second 3D environment includes a stereoscopic image pair including eft eye content corresponding to a left eye viewpoint and right eye content corresponding to a right eye viewpoint. In some aspects, the data representing the second 3D environment includes a 180-degree stereo image. In some aspects, the data representing the second 3D environment includes two-dimensional (2D) image data and depth data.

In some aspects, determining portal content includes rendering at least a portion of the data representing the second 3D environment on at least a portion of a sphere. In some aspects, the data representing the second 3D environment includes a three-dimensional (3D) model. In some aspects, the data representing the second 3D environment is obtained during a communication session between the first electronic device and a second electronic device.

In some aspects, the sensor data captured in the physical environment of the second electronic device is obtained by one or more sensors of the second electronic device. In some aspects, the first 3D environment is an extended reality (XR) environment. In some aspects, the first electronic device or the second electronic device includes a head-mounted device (HMD).

In general, one innovative aspect of the subject matter described in this specification can be embodied in methods, at a first electronic device including one or more processors and one or more sensors, that include the actions of obtaining sensor data captured via the one or more sensors in a physical environment associated with the first electronic device, determining data representing a first three-dimensional (3D) environment, wherein the data representing the first 3D environment is generated based at least in part on the sensor data and a parameter identifying an orientation or a field of view of the first electronic device, and providing the data representing the first 3D environment to a second electronic device.

These and other embodiments can each optionally include one or more of the following features.

In some aspects, determining data representing the first 3D environment includes synthesizing data representing a portion of the first 3D environment not represented in sensor data captured in the physical environment of the first electronic device.

In some aspects, synthesizing data is performed based on detecting a change a position of the first electronic device within the first 3D environment. In some aspects, synthesizing data is performed based on identifying another portion of the first 3D environment that is not represented in the sensor data

In some aspects, the data representing the first 3D environment is updated based on detecting a change in the first 3D environment. In some aspects, the data representing the first 3D environment is updated based on detecting a change in the physical environment of the second electronic device. In some aspects, the data representing the first 3D environment is updated based on detecting that a change in a position of the first electronic device exceeds a threshold.

In some aspects, the method further includes the actions of determining, based on the data representing the first 3D environment, a first lighting condition associated with an area of the first 3D environment, and updating the data representing the first 3D environment for the area associated with the first lighting condition in the first 3D environment.

In some aspects, determining the data representing the first 3D environment includes determining a coverage of a background associated with the physical environment of the first electronic device based on the sensor data, and in response to determining that the coverage of the background captured of the physical environment is below a threshold amount, providing synthesized data as the data representing the first 3D environment.

In some aspects, a blurring effect is applied by the first electronic device to at least a portion of the data representing the first 3D environment provided to the second electronic device. In some aspects, the parameter identifying the orientation or the field of view of the first electronic device is based on determining a pose of the first electronic device. In some aspects, the method further includes the actions of providing data representing a user of the first electronic device to the second electronic device. In some aspects, the data representing the user of the first electronic device is provided with a frequency higher than the data representing the first 3D environment.

In some aspects, the second electronic device is configured to display a view of a portion of the data representing the first 3D environment within a portal within a view of a second 3D environment. In some aspects, the first electronic device and the second electronic device are operatively communicating during a communication session. In some aspects, the first electronic device or the second electronic device includes an HMD.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIGS. 1A-1B illustrate exemplary electronic devices operating in a physical environment, in accordance with some implementations.

FIG. 2 illustrates a view, provided via a device, of the three-dimensional (3D) physical environment of FIGS. 1A-1B, in accordance with some implementations.

FIG. 3 illustrates an exemplary electronic device operating in a different physical environment than the physical environment of FIGS. 1A-1B, in accordance with some implementations.

FIG. 4 illustrates an exemplary 3D environment generated based on the physical environment of FIG. 3 and a portal displaying portal content within the 3D environment, in accordance with some implementations.

FIG. 5 illustrates an exemplary interaction with the portal content displayed within the portal of FIG. 4, in accordance with some implementations.

FIG. 6 illustrates exemplary electronic devices operating in different physical environments during a communication session, in accordance with some implementations.

FIGS. 7A-7D, 8A-8D, 9A-9D, and 10A-10D illustrate exemplary environments for displaying, in a view of a first 3D environment, a portal with portal content that depicts a portion of a second 3D environment viewed through the portal from different viewpoints, in accordance with some implementations.

FIG. 11 is a process flow chart illustrating an exemplary process to provide portal content based on data from a first 3D environment to be displayed in a portal within a view of second 3D environment, in accordance with some implementations.

FIG. 12 is a flowchart illustrating a method for displaying, in a view of a first 3D environment, a portal with portal content that depicts a portion of a second 3D environment viewed through the portal from a viewpoint, in accordance with some implementations.

FIG. 13 is a flowchart illustrating another method for displaying, in a view of a first 3D environment, a portal with portal content that depicts a portion of a second 3D environment viewed through the portal from a viewpoint, in accordance with some implementations.

FIG. 14 is a block diagram of an electronic device of in accordance with some implementations.

FIG. 15 is a block diagram of a head-mounted device (HMD) in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

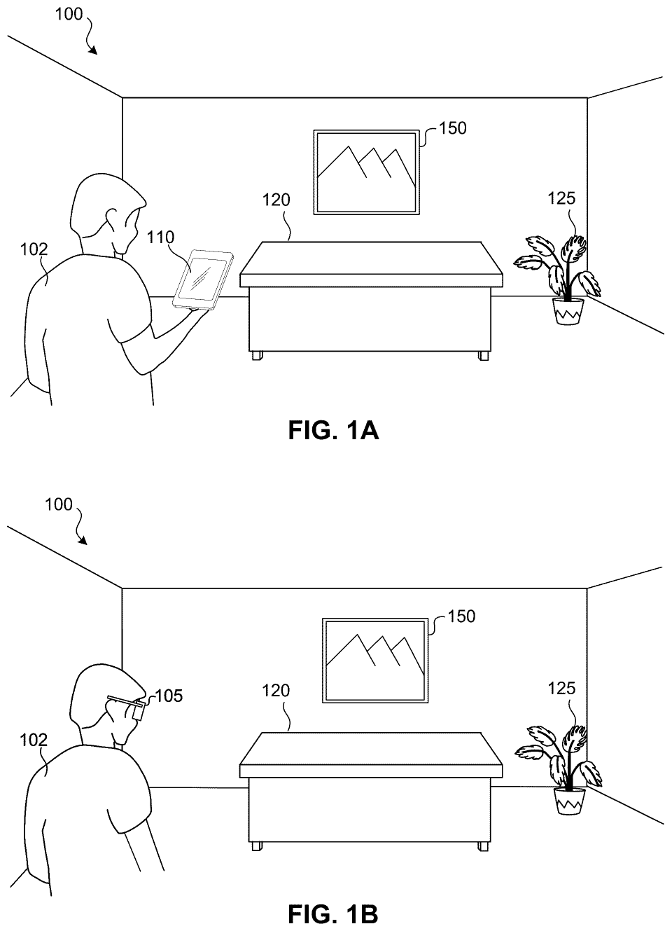

FIGS. 1A-1B illustrate exemplary electronic devices 105 and 110 operating in a physical environment 100. In the example of FIGS. 1A-1B, the physical environment 100 is a room that includes a desk 120. The electronic devices 105 and 110 may include one or more cameras, microphones, depth sensors, or other sensors that can be used to capture information about and evaluate the physical environment 100 and the objects within it, as well as information about the user 102 of electronic devices 105 and 110. The information about the physical environment 100 and/or user 102 may be used to provide visual and audio content and/or to identify the current location of the physical environment 100 and/or the location of the user within the physical environment 100.

In some implementations, views of an extended reality (XR) environment may be provided to one or more participants (e.g., user 102 and/or other participants not shown) via electronic devices 105 (e.g., a wearable device such as an HMD) and/or 110 (e.g., a handheld device such as a mobile device, a tablet computing device, a laptop computer, etc.). Such an XR environment may include views of a 3D environment that is generated based on camera images and/or depth camera images of the physical environment 100 as well as a representation of user 102 based on camera images and/or depth camera images of the user 102. Such an XR environment may include virtual content that is positioned at 3D locations relative to a 3D coordinate system (e.g., a 3D space) associated with the XR environment, which may correspond to a 3D coordinate system of the physical environment 100.

In some implementations, video (e.g., pass-through video depicting a physical environment) is received from an image sensor of a device (e.g., device 105 or device 110) and used to present the XR environment. In other implementations, optical see-through may be used to present the XR environment by overlaying virtual content on a view of the physical environment seen through a translucent or transparent display. In some implementations, a 3D representation of a virtual environment is aligned with a 3D coordinate system of the physical environment. A sizing of the 3D representation of the virtual environment may be generated based on, inter alia, a scale of the physical environment or a positioning of an open space, floor, wall, etc. such that the 3D representation is configured to align with corresponding features of the physical environment. In some implementations, a viewpoint within the 3D coordinate system may be determined based on a position of the electronic device within the physical environment. The viewpoint may be determined based on, inter alia, image data, depth sensor data, motion sensor data, etc., which may be retrieved via a virtual inertial odometry system (VIO), a simultaneous localization and mapping (SLAM) system, etc.

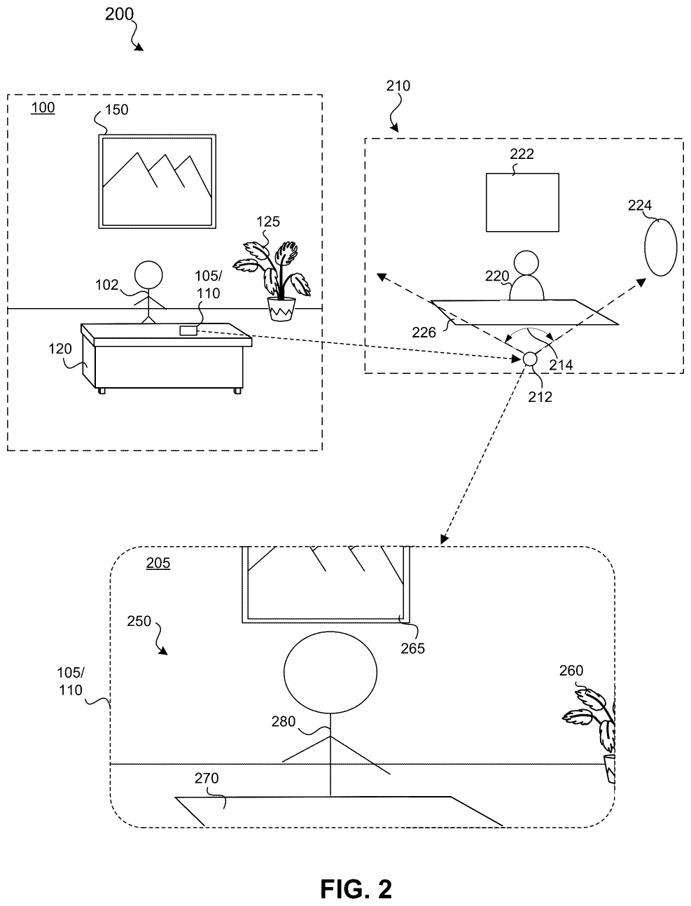

FIG. 2 is an example of an operating environment 200 of a device (e.g., device 105 and/or device 110) used within physical environment 100 and an example view 205 from the device in accordance with some implementations. In particular, operating environment 200 illustrates the user 102 behind desk 120 in the physical environment 100 of FIGS. 1A-1B. As illustrated, the user 102, in the operating environment 200, has placed a device (e.g., device 105 and/or device 110) at the far edge of desk 120 in order to start a scan of the environment 100. For example, operating environment 200 illustrates the process of creating an environment representation 210 of the current physical environment 100 to identify key features of the physical environment 100. A handheld device (e.g., device 110) is illustrated, however, an HMD (e.g., device 105) may also be used to capture the background of the physical environment 100 (e.g., portions of the environment behind the user) that can be utilized during a communication session. For example, FIG. 2 illustrates capturing a background scene of an environment, such that when the user wears the HMD (e.g., device 105) during a communication session, the system can use the background scene sensor data that was previously captured (e.g., when the HMD was previously facing the background scene)_to generate a representation of that background because the HMD, during a live communication session, would not be able to capture the background data unless the user faces the HMD towards that area. In other words, since sensors (e.g., cameras) on HMDs are typically positioned close to the face of the user to capture facial and body images, and capture images of the environment from the user's perspective, HMDs are often unable to capture live image data of the background from the perspective of another user (e.g., example viewpoint 214 of the device sitting at the desk).

Environment representation 210 illustrates an example representation of physical environment 100 from viewpoint 214 corresponding to the perspective of the electronic devices 105/110 as depicted by location indicator 212. Environment representation 210 includes appearance and/or location/position information as indicated by object 222 (e.g., wall hanging 150), object 224 (e.g., plant 125), object 226 (e.g., desk 120). Additionally, environment representation 210 identifies the appearance and/or location of user 102, as illustrated by representation 220. In some implementations, environment representation 210 may include representations of environment 100 that were generated using scene sensor data that was previously captured (e.g., for portions of physical environment 100 behind user 102) as well as a representation of user 102 using current sensor data. In these implementations, representations for portions of physical environment 100 in front of user 102 may not be included in environment representation 210 (e.g., object 226 representing desk 120 may not be included).

As shown in FIG. 2, device 105 or device 110 may provide a view 205 of 3D environment 250 from the perspective of device 105 or device 110 using environment representation 210 (e.g., from the perspective of location indicator 212 such as a forward facing camera, or an XR environment that represents a forward facing camera view of device 105 or device 110). For example, view 205 illustrates 3D environment 250 that includes representation 260 of plant 125, representation 265 of wall hanging 150, representation 270 of desk 120, and representation 280 of the user 102. As mentioned above, in some implementations, representations of portions of environment 100 located in front of user 102 may not be included in environment representation 210 and may not be presented in view 205 (e.g., representation 270 of desk 120). Representations 260, 265, 270, may be images (e.g., video) of the actual objects, may be views of each physical object as seen through a transparent or translucent display, may be virtual content that represents each physical object, or representations 260, 265, 270 may be a combination of virtual content and images and/or pass-through video (e.g., an XR experience). Similarly, representation 280 of the user 102 may be an actual video of the user 102, may be generated virtual content that represents the user 102 (e.g., an avatar), or may be a view of the user 102 as seen through a transparent or translucent display, as further discussed herein. In some implementations, as further described below, in addition or alternatively to presenting view 205, device 105 or device 110 may provide environment representation 210, or another representation derived therefrom, to a remote device during a multi-user communication session.

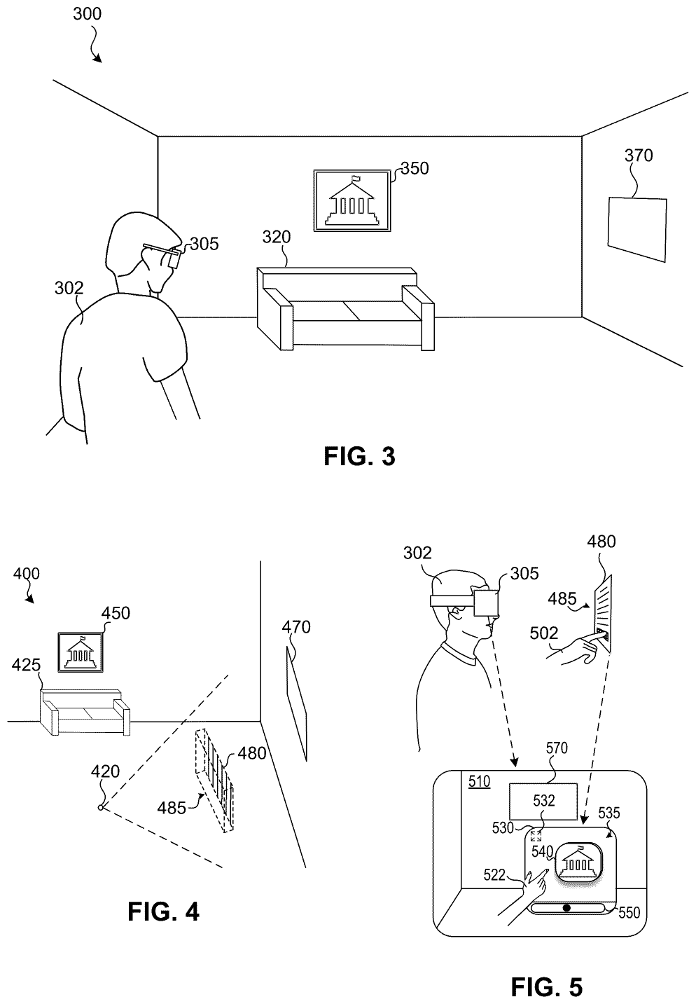

FIG. 3 illustrates exemplary electronic device 305 operating in a physical environment 300. In particular, FIG. 3 illustrates an exemplary electronic device 305 operating in a different physical environment (e.g., physical environment 300) than the physical environment of FIGS. 1A-1B (e.g., physical environment 100). In the example of FIG. 3, the physical environment 300 is a room that includes a couch 320, a wall hanging 350, and a television screen 370. The electronic device 305 may include one or more cameras, microphones, depth sensors, or other sensors that can be used to capture information about and evaluate the physical environment 300 and the objects within it, as well as information about the user 302 of electronic device 105. The information about the physical environment 300 and/or user 302 may be used to provide visual and audio content and/or to identify the current location of the physical environment 300 and/or the location of the user within the physical environment 300.

In some implementations, views of an XR environment may be provided to one or more participants (e.g., user 302 and/or other participants not shown, such as user 102) via electronic devices 305, e.g., a wearable device such as an HMD, and/or a handheld device such as a mobile device, a tablet computing device, a laptop computer, etc. (e.g., device 110). Such an XR environment may include views of a 3D environment that is generated based on camera images and/or depth camera images of the physical environment 300 as well as a representation of user 302 based on camera images and/or depth camera images of the user 302. Such an XR environment may include virtual content that is positioned at 3D locations relative to a 3D coordinate system (e.g., a 3D space) associated with the XR environment, which may correspond to a 3D coordinate system of the physical environment 300.

In some implementations, video (e.g., pass-through video depicting a physical environment) is received from an image sensor of a device (e.g., device 305) and used to present the XR environment. In other implementations, optical see-through may be used to present the XR environment by overlaying virtual content on a view of the physical environment seen through a translucent or transparent display. In some implementations, a 3D representation of a virtual environment is aligned with a 3D coordinate system of the physical environment. A sizing of the 3D representation of the virtual environment may be generated based on, inter alia, a scale of the physical environment or a positioning of an open space, floor, wall, etc. such that the 3D representation is configured to align with corresponding features of the physical environment. In some implementations, a viewpoint within the 3D coordinate system may be determined based on a position of the electronic device within the physical environment. The viewpoint may be determined based on, inter alia, image data, depth sensor data, motion sensor data, etc., which may be retrieved via a virtual inertial odometry system (VIO), a simultaneous localization and mapping (SLAM) system, etc.

FIG. 4 illustrates an exemplary 3D environment 400 generated based on the physical environment 300 of FIG. 3 and a portal 480 displaying portal content 485 within the 3D environment, in accordance with some implementations. The portal 480 may also referred to herein as a projection of a 3D image. The 3D environment 400 includes representations 425, 450, and 470 of the couch 320, wall hanging 350, and television screen 370, respectively, of the physical environment 300. The 3D environment 400 also includes portal content 485 that is displayed to form a shape of the portal 480. In some implementations, the shape of the portal 480 may be any geometric shape that is able to project content (e.g., a 3D virtual shape such as a half-sphere, aka a “snow globe” view). The portal content 485 being displayed by portal 480 constitutes the portal (e.g., a projection of an image), as discussed herein.

The electronic device 305 provides views of the physical environment 300 that include depictions of the 3D environment 400 from a viewpoint 420 (e.g., also referred to herein as a viewer position), which in this example is determined based on the position of the electronic device 305 in the physical environment 300 (e.g., a viewpoint of the user 302, also referred to herein as the “viewer's position” or “viewer's viewpoint”). Thus, as the user 302 moves with the electronic device 305 (e.g., an HMD) relative to the physical environment 300, the viewpoint 420 corresponding the position of the electronic device 305 is moved relative to the 3D environment 400. The view of the 3D environment provided by the electronic device changes based on changes to the viewpoint 420 relative to the 3D environment 400. In some implementations, the 3D environment 400 does not include representations of the physical environment 300, for example, including only virtual content corresponding to a virtual reality environment.

FIG. 5 illustrates an exemplary interaction with the portal content 485 displayed within the portal 480 of FIG. 4, in accordance with some implementations. For example, FIG. 5 illustrates an exemplary “direct” interaction involving a user's hand 502 virtually touching a UI element of a user interface (e.g., portal content 485) within the portal 480. In this example, the user 302 is using device 305 to view and interact with an XR environment that may include a user interface 530 (e.g., portal content 485) within a view of the XR environment 510. A direct interaction recognition process may use sensor data and/or UI information to determine, for example, which UI element the user's hand is virtually touching and/or where on that UI element the interaction occurs. Direct interaction may additionally (or alternatively) involve assessing user activity to determine the user's intent, e.g., did the user intend to a straight tap gesture through the UI element or a sliding/scrolling motion along the UI element. Such recognition may utilize information about the UI elements, e.g., regarding the positions, sizing, type of element, types of interactions that are capable on the element, types of interactions that are enabled on the element, which of a set of potential target elements for a user activity accepts which types of interactions, etc.

FIG. 5 further illustrates a view of an XR environment 510, provided via the device 305, of virtual elements within the 3D physical environment of FIG. 3, in which the user 302 may perform an interaction. In this example, the user 302 makes a hand gesture relative to content presented in view of an XR environment 510 provided by a device (e.g., device 305). The view of the XR environment 510 includes an exemplary user interface 530 of an application and a depiction 570 of television screen 370 (e.g., a representation of a physical object that may be viewed as pass-through video or may be a direct view of the physical object through a transparent or translucent display). Additionally, the view of the XR environment 510 includes a representation 522 of a hand/arm 502 of the user 302. Providing such a view may involve determining 3D attributes of the physical environment 300 and positioning virtual content, e.g., user interface 530, in a 3D coordinate system corresponding to that physical environment 300.

In the examples of FIG. 5, the user interface 530 include various content items, including a background portion 535, an application portion 540, a control element 532, and a scroll bar 550. The application portion 540 is displayed with 3D effects in the view provided by device 305. The user interface 530 (e.g., portal content 485 displayed within the portal 480) is simplified for purposes of illustration and user interfaces in practice may include any degree of complexity, any number of content items, and/or combinations of 2D and/or 3D content. The user interface 530 may be provided by operating systems and/or applications of various types including, but not limited to, messaging applications, web browser applications, content viewing applications, content creation and editing applications, or any other applications that can display, present, or otherwise use visual and/or audio content.

In this example, the background portion 535 of the user interface 530 is flat. In this example, the background portion 535 includes all aspects of the user interface 530 being displayed except for the icon 532 and scroll bar 550. Displaying a background portion of a user interface of an operating system or application as a flat surface may provide various advantages. Doing so may provide an easy to understand or otherwise use a portion of an XR environment for accessing the user interface of the application. In some implementations, a shape of the user interface (e.g., portal 485) may be curved, such as a half-sphere, to provide a different view of depth of the content within the user interface as it is being presented within a view of a 3D environment. In some implementations, multiple user interfaces (e.g., corresponding to multiple, different applications) are presented sequentially and/or simultaneously within an XR environment, e.g., within one or more colliders or other such components.

In some implementations, the positions and/or orientations of such one or more user interfaces may be determined to facilitate visibility and/or use. The one or more user interfaces may be at fixed positions and orientations within the 3D environment. In such cases, user movements would not affect the position or orientation of the user interfaces within the 3D environment.

The position of the user interface within the 3D environment may be based on determining a distance of the user interface from the user (e.g., from an initial or current user position). The position and/or distance from the user may be determined based on various criteria including, but not limited to, criteria that accounts for application type, application functionality, content type, content/text size, environment type, environment size, environment complexity, environment lighting, presence of others in the environment, use of the application or content by multiple users, user preferences, user input, and numerous other factors.

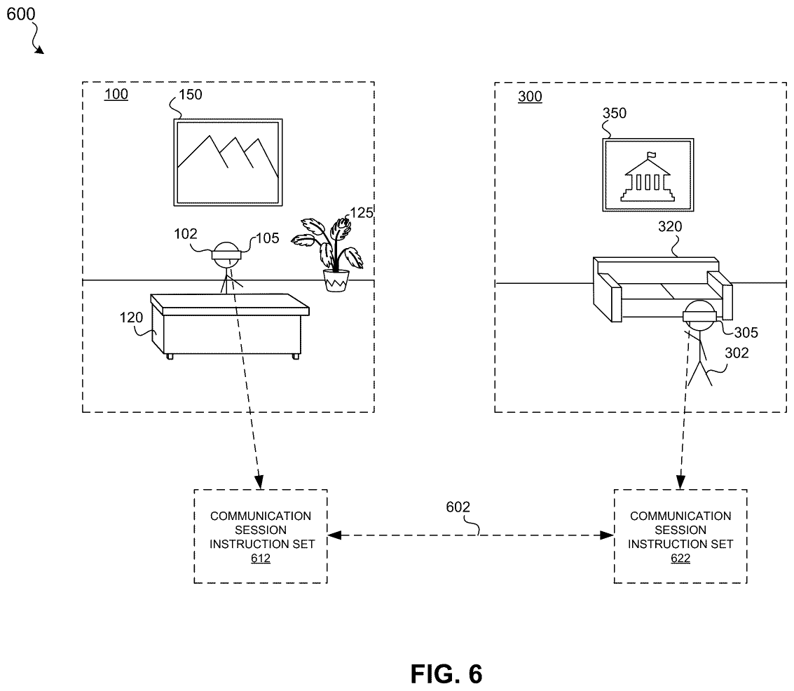

FIG. 6 illustrates exemplary operating environment 600 of electronic devices 105 and 305 operating in different physical environments 100 and 300, respectively, during a communication session, in accordance with some implementations, e.g., while the electronic devices 105, 305 are sharing information with one another or an intermediary device such as a communication session server. In this example of FIG. 6, the physical environment 100 is a room that includes a wall hanging 150, a plant 125, and a desk 120. The electronic device 105 includes one or more cameras, microphones, depth sensors, or other sensors that can be used to capture information about and evaluate the physical environment 100 and the objects within it, as well as information about the user 102 of the electronic device 105. For example, the electronic device 105 may use the captured information to generate an environment representation of physical environment 100 similar or identical to environment representation 210, described above. The information about the physical environment 100 and/or user 102 (e.g., environment representation) may be used to provide visual and audio content during the communication session. For example, a communication session may provide views to one or more participants (e.g., users 102, 302) of a 3D environment that is generated based on camera images and/or depth camera images of the physical environment 100 as well as a representation of user 102 based on camera images and/or depth camera images of the user 102.

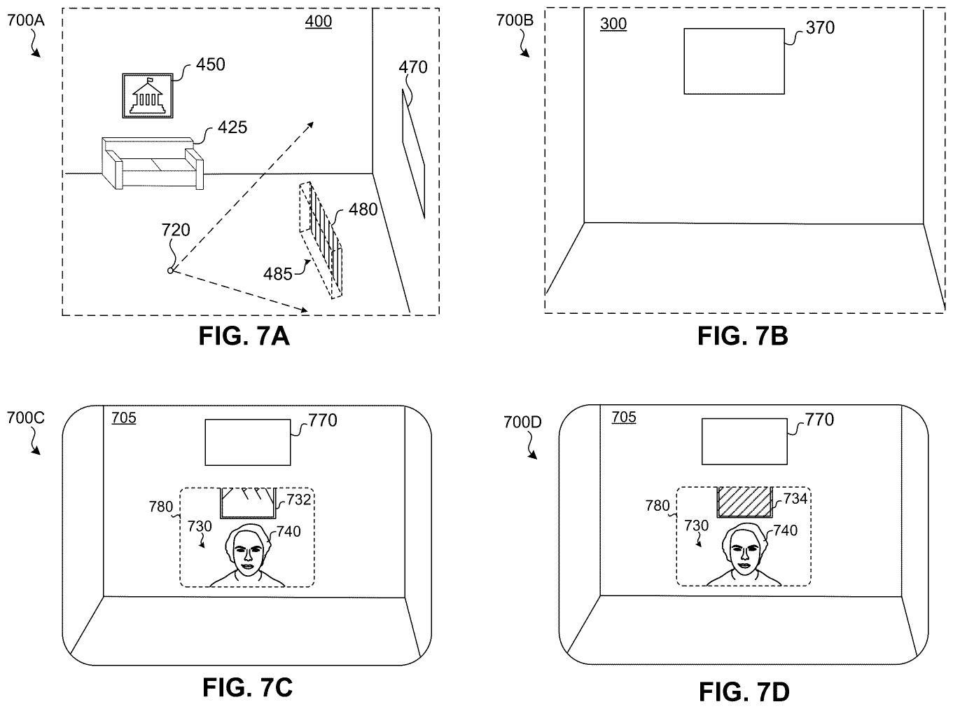

In this example, a portion of the physical environment 300 of FIG. 3 is illustrated, which is a view of a portion of a room that includes a wall hanging 350 and a couch 320, and a user 302 wearing an electronic device 305 (e.g., an HMD). The electronic device 305 includes one or more cameras, microphones, depth sensors, or other sensors that can be used to capture information about and evaluate the physical environment 300 and the objects within it, as well as information about the user 302 of the electronic device 302, as discussed herein with reference to FIG. 3. For example, the electronic device 305 may use the captured information to generate an environment representation of physical environment 300 similar to environment representation 210 generated for physical environment 100, described above. The information about the physical environment 300 and/or user 302 may be used to provide visual and audio content during the communication session. For example, a communication session may provide views of a 3D environment that is generated based on camera images and/or depth camera images (from electronic device 105) of the physical environment 100 as well as a representation of user 102. For example, a representation of a 3D environment (e.g., environment representation 210) may be sent by the device 105 using a communication session instruction set 612 in communication with the device 305 using a communication session instruction set 622 (e.g., via a network connection 602). Similarly, a representation of a 3D environment (e.g., similar to environment representation 210) may be sent by the device 305 using the communication session instruction set 622 in communication with the device 105 using the communication session instruction set 612 (e.g., via a network connection 602). However, it should be noted that representations of the users 102, 302 may be provided in other 3D environments. For example, a communication session may involve representations of either or both users 102, 302 that are positioned within any entirely virtual environment or an XR environment that includes some physical environment representations and some virtual environment representations and may be viewed to the other user within a portal. Such views of a portal, and different aspects of the views of the user representations and the backgrounds for each user's environment with respect to a viewpoint, are illustrated in the examples of FIGS. 7-10 described next.

FIGS. 7A-10D illustrate exemplary environments for displaying, in a view of a first 3D environment, a portal with portal content that depicts a portion of a second 3D environment viewed through the portal from different viewpoints, in accordance with some implementations. In particular, FIGS. 7A-10D illustrate the changes in a view of content within a portal for a user (e.g., user 302) wearing or using a device such as an HMD (e.g., device 305) during a communication session with another user (e.g., user 102) wearing and/or using another device such as an HMD (e.g., device 105). For example, FIGS. 7-10 illustrate different portal content views as the user 302 moves about his or her room (e.g., physical environment 300) and thus there are different viewpoints (e.g., viewpoint 720, 820, 920, 1020) and/or the user 102 moves about his or her room (e.g., physical environment 100) during the communication session. As mentioned above, HMDs may be limited in their ability to update a view of a user and a user's background because the external facing cameras may not be able to capture the background environment (e.g., the portion of the physical environment behind the user) during communication session from the perspective of a typical video chat session (e.g., having the camera positioned 1 to 2 meters in front of the user to capture both the user and the background data). Thus, when both users are wearing HMDs during a communication session, if there is a desire to provide the actual (“live”) background, or at least a representation of the background during the session, then the system may utilize previously captured images of the environment (e.g., images of at least a portion of the environment captured before the communication session) to represent the background, or the system may hallucinate some (e.g., any gaps in or unseen portions of the background) or all of the background. Then based on a sender's position with respect to the background, and/or a viewer's viewpoint position, the background may be displayed and updated accordingly.

FIGS. 7A, 8A, 9A, and 10A, illustrate exemplary environments 700A, 800A, 900A, and 1000A, respectively, of the exemplary 3D environment 400 of FIG. 4, but from a different viewpoint (e.g., viewpoint 720, 820, 920, 1020). In particular, FIGS. 7A, 8A, 9A, and 10A depict the 3D environment 400 which includes a portal 480 displaying portal content 485, and representations 425, 450, and 470 of the couch 320, wall hanging 350, and television screen 370, respectively, of the physical environment 300.

FIGS. 7B, 8B, 9B, and 10B, illustrate exemplary environments 700B, 800B, 900B, and 1000B, respectively, of a physical environment 300 of FIG. 3, but from different viewpoints (e.g., viewpoint 720, 820, 920, 1020). In particular, FIGS. 7B, 8B, 9B, and 10B depict a view of the physical environment 300 from a particular viewpoint, and one or more objects that may be within the view, such as television screen 370 and a couch 320. The view of FIGS. 7B, 8B, 9B, and 10B of the physical environment 300 may be an actual view of a user (e.g., user 302) from the particular viewpoint before wearing the device 305 (e.g., an HMD), or may be a pass-through video or optical see-through view of physical environment 300 via the device 305, before virtual content is displayed (e.g., portal content 485).

FIGS. 7C-D, 8C-D, 9C-D, and 10C-D, illustrate exemplary views 700C-D, 800C-D, 900C-D, and 1000C-D, respectively, of the 3D environment 400, but from different viewpoints (e.g., viewpoint 720, 820, 920, 1020). In particular, FIGS. 7C-D, 8C-D, 9C-D, and 10C-D depict a view of an XR environment that represents the physical environment 300 and a view of the portal content 485 within the portal 480 from a particular viewpoint (e.g., a viewer position of user 302 within the physical environment 300). In these examples of views 700C-D, 800C-D, 900C-D, and 1000C-D, during a communication session, the electronic device 305 provides different views (e.g., view 705, 805, 905, and 1005, respectively), of a portal (e.g., portals 780, 880, 980, and 1080, respectively) that enables the user 302 to view a representation of at least a portion of the user 102 (e.g., user representations 740, 840, 940, and 1040, respectively), and view a representation of at least a portion of the environment/background behind user 102 in physical environment 100 (e.g., backgrounds 730, 830, 930, and 1030, respectively). For example, the user 302 can view the representation of the user 102 and at least a portion of the physical environment 100 of user 102 (e.g., the office/room of user 102). Additionally, the views may include, depending on the viewpoint, a representation of the television screen 370 (e.g., representations 770, 870, 970, and 1070, respectively). In some implementations, the representation (e.g., avatar) of the user 102 and/or the background view, may provide a live, real-time view of the user 102, e.g., based on sensor data including images and other sensor data of the user 102 obtained during the communication session. As the user 102 moves around, makes hand gestures, and makes facial expressions, corresponding movements, gestures, and expressions may be displayed for the representation in each view. For example, as the user 102 moves left two feet in physical environment 100, each view 705, 805, 905, and 1005, may show the representation (e.g., an avatar) moving left two feet in the view corresponding to the user 102 movement.

For the viewpoint 720 of FIGS. 7A-D, the user 302 and/or the device 305 is directly facing the portal content 485 of the portal 480. For example, during a normal communication session (e.g., a video chat session), each user is facing each other directly and positioned at a particular distance from a particular viewpoint (e.g., 1 to 2 meters from a camera source).

In FIGS. 7C and 7D, the view 705 of the portal 780 includes the representation 740 of the user 102 appearing to look directly back at the viewpoint 720 (e.g., looking directly at the user 302). However, the background data 730 between FIGS. 7C and 7D is different, which may be based on one or more features/factors further described herein (e.g., missing data, privacy features/blurring, updated content, etc.). For example, the representation 732 of the wall hanging 150 in FIG. 7C appears to have the same appearance as illustrated in the physical environment 100 of FIG. 1 (e.g., a live image or a representation that is not altered of the wall hanging 150), while the representation 734 of the wall hanging 150 in FIG. 7D has been filtered, such as a privacy blocking feature (e.g., blocking any personal identifying information, such as a picture or photograph of a person or family member). For example, the frame of the representation 734 of the wall hanging 150 in FIG. 7D remains, but the content within the frame has been blocked.

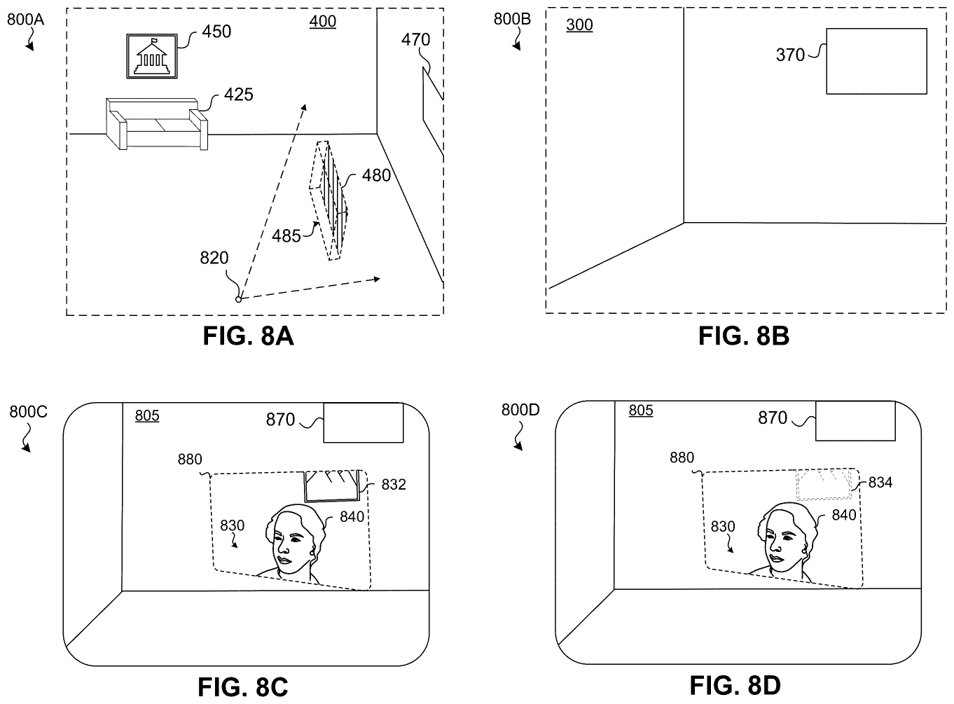

In FIGS. 8C and 8D, the view 805 of the portal 880 includes the representation 840 of the user 102 appearing to look slightly away from the viewpoint 820. For example, the avatar of user 102 appears to continue to be looking at the original viewpoint 720 of FIG. 7, in other words, the representation of user 102 during a communication session may be anchored at a 3D space within the portal 880, but the user 302 can look around the background 830 of that 3D space (e.g., change a viewpoint). However, the background data 830 between FIGS. 8C and 8D is different, which may be based on one or more features/factors further described herein (e.g., missing data, privacy features/blurring, updated content, etc.). For example, the representation 832 of the wall hanging 150 in FIG. 8C appears to have the same or similar appearance as illustrated in the physical environment 100 of FIG. 1 (e.g., a live image or a representation that is not altered of the wall hanging 150), while the representation 834 of the wall hanging 150 in FIG. 8D has been filtered, such as a blurring technique (e.g., providing at least a portion of a representation of a sender's background within a portal to give some context of where the sender is calling from, but not providing a full clear picture of that environment/background).

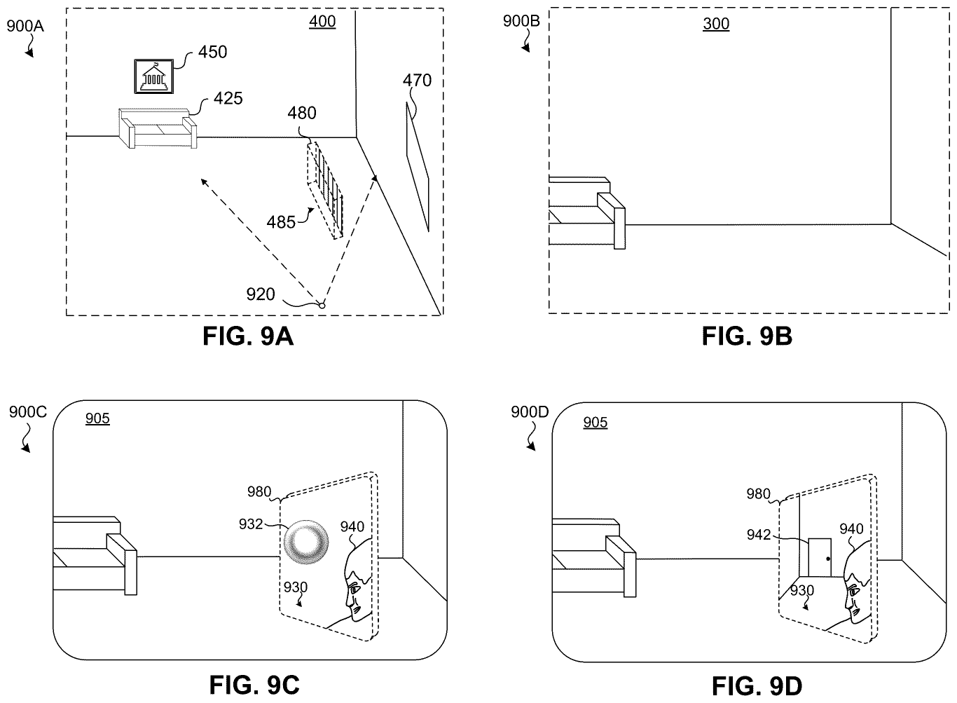

In FIGS. 9C and 9D, the view 905 of the portal 980 includes a portion of the representation 940 of the user 102 appearing to look away from the viewpoint 920. For example, the avatar of user 102 appears to continue to be looking at the original viewpoint 720 of FIG. 7, in other words, the representation of user 102 during a communication session may be anchored at a 3D space within the portal 980, but the user 302 can look around the background 930 of that 3D space (e.g., change a viewpoint). As illustrated in FIG. 9A, the user 302 at viewpoint 920 appears to be looking from a wide angle, such that the user 302 may be able to see different angles of the user's 102 background/environment (e.g., physical environment 100). However, the background data 930 between FIGS. 9C and 9D is different, which may be based on one or more features/factors further described herein (e.g., missing data, privacy features/blurring, updated content, etc.). For example, FIG. 9C illustrates a light source anomaly 932 that may be detected in the environment 100 (e.g., poor lighting conditions), thus a less than desirable appearance in the background data 930. In some implementations, the system and techniques described herein may be able to detect the light source anomaly 932 and provide a correction. Thus, for example, FIG. 9D illustrates an example of hallucinating background content to correct such anomalies, and/or to update the background 930 based on one or more factors (e.g., update with a portion of virtual background overlaying the representations of the real background, or replacing the entire background with hallucinated content, e.g., a virtual background during a video chat session). In particular, FIG. 9D includes a representation 942 of a door, walls, and a floor, that were added to the background 930. In some implementations, the additional content (e.g., representation 942) may be added based on updated sensor data from the device 105 as the user either moves around in his or her physical environment 100, or is generated by device 305 or device 105 based on obtained semantic data (e.g., a semantic 3D point cloud), that identifies that a door may be located at that particular location. In other words, hallucinate background data (e.g., the door) based on identified incomplete data.

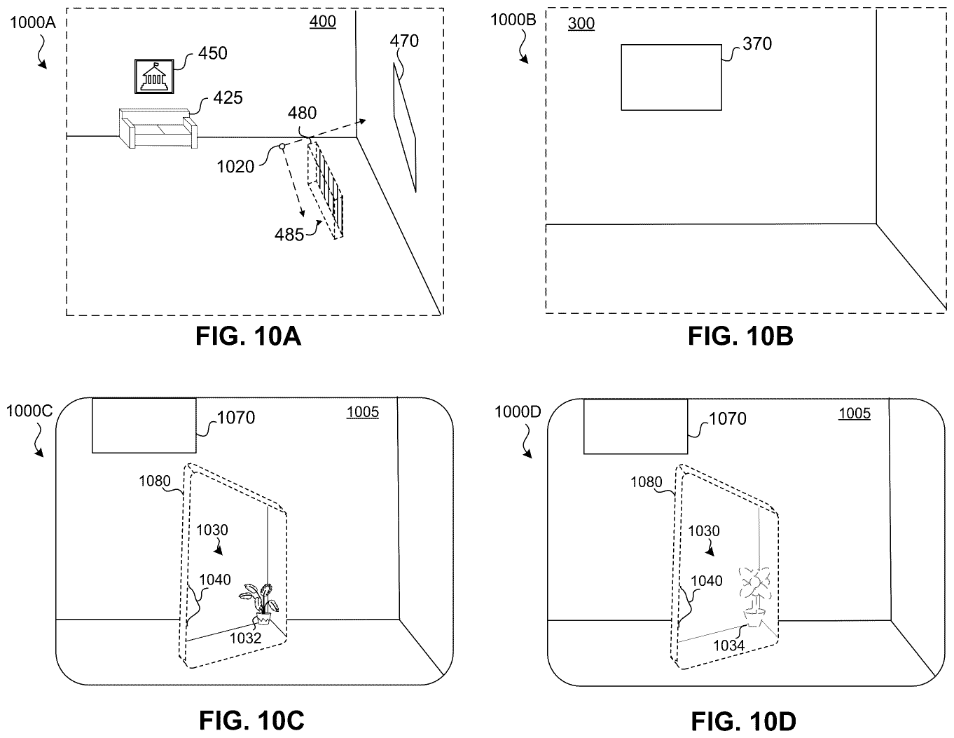

In FIGS. 10C and 10D, the view 1005 of the portal 1080 includes a small portion of the representation 1040 of the user 102 because the viewpoint 1020 is at a very wide angled viewpoint with respect to the original viewpoint 720 of FIG. 7. In other words, the representation of user 102 during a communication session may be anchored at a 3D space within the portal 1080, but the user 302 can look around the background 1030 of that 3D space (e.g., change a viewpoint). As illustrated in FIG. 10A, the user 302 at viewpoint 1020 appears to be looking from a very wide angle and almost in line with the plane of the portal 480 as illustrated in FIG. 10A, such that the user 302 may be able to see different portions of the user's 102 background/environment (e.g., physical environment 100), if the system allows the user to view the other areas. However, the background data 1030 between FIGS. 10C and 10D is different, which may be based on one or more features/factors further described herein (e.g., missing data, privacy features/blurring, updated content, etc.). For example, FIG. 10C illustrates a representation 1032 of the plant 125 of the physical environment 100 in the background 1030. For example, the sensor data obtained from the device 105 of the physical environment 100 allows the system to generate the representation 1032 (e.g., an area in the background that was captured by the device). FIG. 10D illustrates an example of hallucinating background content to update the background 1030 based on one or more factors (e.g., update with a portion of virtual background overlaying the representations of the real background, or replacing the entire background with hallucinated content, e.g., a virtual background during a video chat session). In particular, FIG. 10D includes a representation 1034 of a fake plant. The representation 1034 may be generated to represent a known location of the plant based on semantic data or may have been randomly generated because there was no known data for that area. Alternatively, instead of hallucinating added content for areas in the background data 1030 that are unknown, a blurred and/or colored background may be applied (e.g., a faded colored wall, such as a backdrop background for a portrait or a photograph). In some implementations, the additional content (e.g., representation 1034) may be added based on updated sensor data from the device 105 as the user either moves around in his or her physical environment 100 or is generated by device 305 or device 105 based on obtained semantic data (e.g., a semantic 3D point cloud), that identifies that a plant may be located at that particular location. In other words, hallucinate background data (e.g., the plant) based on identified data to fill in the incomplete data.

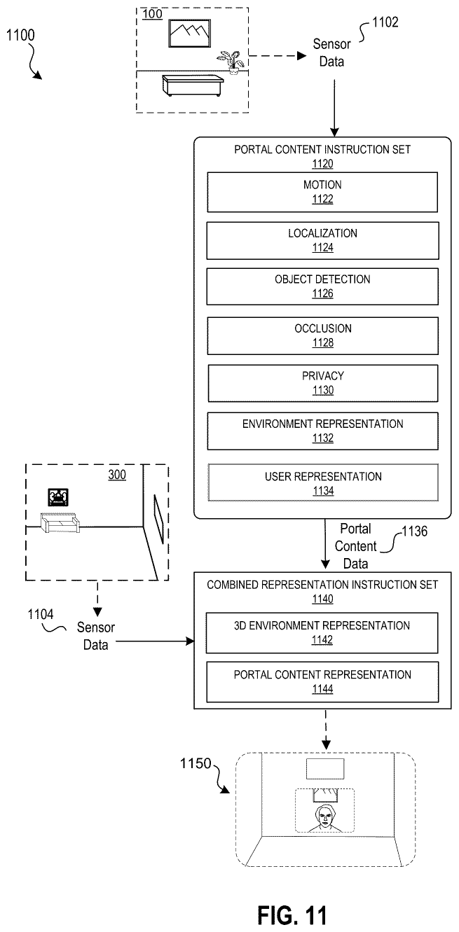

FIG. 11 is a process flow chart illustrating an exemplary process 1100 to provide portal content based on data from a first 3D environment to be displayed in a portal within a view of second 3D environment, in accordance with some implementations. In some implementations, the process 1100 is performed on a device (e.g., device 105, 110, 305, and the like), such as a mobile device, desktop, laptop, HMD, or server device. In some implementations, the process flow 1100 is performed on processing logic, including hardware, firmware, software, or a combination thereof. In some implementations, the process flow 1100 is performed on a processor executing code stored in a non-transitory computer-readable medium (e.g., a memory).

The process flow 1100 obtains sensor data 1102 from a first physical environment (e.g., device 105 obtaining sensor data of physical environment 100). The sensor data 1102 may include image data, depth data, positional information, and the like. For example, sensors on a device (e.g., camera's, IMU, etc. on device 105, 110, 305, etc.) can capture information about the position, location, motion, pose, etc., of the head and/or body of a user and the environment.

In an example implementation, a portal content generation system for the process 1100 may include a portal content instruction set 1120 and a combined representation instruction set 1140. The portal content instruction set 1120 may include one or more modules that may then be used to analyze the sensor data 1102. The portal content instruction set 1120 may include a motion module 1122 for determining motion trajectory data from motion sensor(s) for one or more objects. The portal content instruction set 1120 may include a localization module 1124 is configured with instructions executable by a processor to obtain sensor data (e.g., RGB data, depth data, etc.) and track a location of a moving device (e.g., device 105, 305, etc.) in a 3D coordinate system using one or more techniques (e.g., track as a user moves around in a 3D environment to determine a particular viewpoint as discussed herein). The portal content instruction set 1120 may include an object detection module 1126 can analyze RGB images from a light intensity camera and/or a sparse depth map from a depth camera (e.g., time-of-flight sensor) and other sources of physical environment information (e.g., camera positioning information from a camera's SLAM system, VIO, or the like such as position sensors) to identify objects (e.g., people, pets, etc.) in the sequence of light intensity images. In some implementations, the object detection module 1126 uses machine learning for object identification. In some implementations, the machine learning model is a neural network (e.g., an artificial neural network), decision tree, support vector machine, Bayesian network, or the like. For example, the object detection module 1126 uses an object detection neural network unit to identify objects and/or an object classification neural network to classify each type of object.

The portal content instruction set 1120 may further include an occlusion module 1128 for detecting occlusions in the object model. For example, if a viewpoint changes for the viewer, and an occlusion is detected, the system may then determine to hallucinate any gaps of data that may be missing based on the detected occlusions between one or more objects. For example, an initial room scan may not acquire image data of the area behind the desk 120 of FIG. 1, but if the user 102 moves to a position where the viewpoint may show that area that was occluded by the original capture viewpoint, then the occlusion module 1128 can indicate which area may need to be hallucinated based on the surrounding (known) data from the original room scan.

The portal content instruction set 1120 may further include a privacy module 1130 that may be based on one or more user settings and/or default system settings that control the amount of blurring or masking particular areas of the background data to be shown to another user during a communication session. For example, based on a threshold distance setting, only a particular radial distance around the user may be displayed within the portal content (e.g., a five-foot radius), and then the remaining portion of the background data would be blurred. Additionally, all of the background data may be blurred for privacy purposes. Additionally (or alternatively), identified objects that show personal identifying information may be modified. For example, as illustrated in FIG. 7D, the representation 734 of the wall hanging 150 was modified (e.g., assuming the mountains depicted on the wall hanging 150 may have also had family members included in the picture).

The portal content instruction set 1120 may further include an environment representation module 1132 and/or a user representation module 1134 for generating data to be used for the representations of the background data and user representations as described herein.

The portal content instruction set 1120, utilizing the one or more modules, generates and sends portal content data 1136 to a combined representation instruction set 1140 that is configured to generate the combined representation 1150 (e.g., a virtual portal positioned within a view of a 3D environment, such as an XR environment). In some implementations, portal content data 1136 may include an environment representation similar or identical to environment representation 210, described above.

The combined representation instruction set 1140 may obtain sensor data 1104 from a viewer's environment (e.g., device 305 obtaining sensor data of physical environment 300). The sensor data 1104 may include image data, depth data, positional information, and the like. For example, sensors on a device (e.g., camera's, IMU, etc. on device 305) can capture information about the position, location, motion, pose, etc., of the head and/or body of a user and the environment. The combined representation instruction set 1140 may include a 3D environment representation module 1142 for generating a view of a representation of a viewer's environment (e.g., optical see-through, pass-through video, or a 3D model of the viewer's environment) based on the obtained sensor data 1104. The combined representation instruction set 1140 may further include a portal content representation module 1144 for generating a view of a portal that includes a representation of a sender's environment based on the obtained portal content data 1136. Thus, the combined representation instruction set 1140 generates the combined representation 1150 based on combining the 3D environment representation of physical environment 300 with the generated portal that includes portal content generated from the sender's physical environment 100, as illustrated in FIGS. 7-10.

One or more of the modules included in the portal content instruction set 1120 may be executed at a sender's device, a viewer's device, or a combination thereof. For example, the device 105 (e.g., a sender's device) obtains sensor data 1102 of the physical environment 100 (e.g., a room scan) and sends the sensor data to the device 305 (e.g., a viewer's device) to be analyzed to generate the portal content, and thus would update the portal content (e.g., avatar and background data) based on the updated sensor data from the device 305. Additionally (or alternatively), the device 105 (e.g., a sender's device) obtains sensor data 1102 of the physical environment 100 (e.g., a room scan) and also analyzes the sensor data to generate the portal content, and then sends the portal content to the device 305 to be displayed and viewed. Additionally (or alternatively), the analysis and the different decision points of when to hallucinate new content, blur out one or more features, etc., may be performed by both the sender's device and the viewer's device.

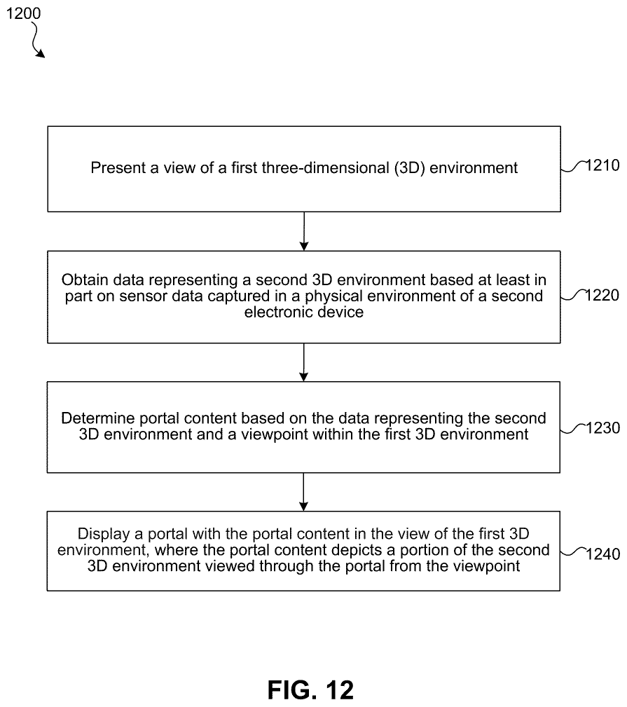

FIG. 12 is a flowchart illustrating a method 1200 for displaying, in a view of a first 3D environment, a portal with portal content that depicts a portion of a second 3D environment viewed through the portal from a viewpoint, in accordance with some implementations. In some implementations, a device such as electronic device 105, 110, 305, etc., performs method 1200. In some implementations, method 1200 is performed on a mobile device (e.g., device 110), desktop, laptop, HMD (e.g., device 105, 305), or server device. The method 1200 is performed by processing logic, including hardware, firmware, software, or a combination thereof. In some implementations, the method 1200 is performed on a processor executing code stored in a non-transitory computer-readable medium (e.g., a memory). In some implementations, the device performing the method 1200 includes a processor and one or more sensors.

In an exemplary implementation, the method 1200 is performed at a first electronic device having a processor. In particular, the following blocks are performed at a viewer's device (e.g., an HMD), such as device 305 and provides a view of a 3D environment (e.g., a viewer's room) with a portal providing views of another user's (e.g., a sender's) background environment. The portal may provide a multi-directional view (e.g., viewpoint dependent) of the other environment that changes as the viewer moves relative to the portal. The background data is provided by the other user's device capturing sensor data of the other user's environment, potentially filling data gaps/hallucinating content, and may be provided to the viewer's device using parameters (e.g., blurring, not depicting other people, providing a limited (e.g., 180° FOV), using updating criteria based on changes/new content, etc.).

At block 1210, the method 1200 presents a view of a first three-dimensional (3D) environment. For example, as illustrated in FIG. 7, the viewing device, device 305, presents a view 705 that includes a representation of the physical environment 300.

At block 1220, the method 1200 obtains data representing a second 3D environment based at least in part on sensor data captured in a physical environment of a second electronic device. For example, as illustrated in FIG. 11, a viewing device, (e.g., device 305) located in the physical environment 300 (e.g., a first environment), may obtain portal content data 1136 that may include an environment representation of a second 3D environment that was generated based on sensor data (e.g., sensor data 1102) of the second 3D environment (e.g., physical environment 100 via device 110 or device 105 from a room scan). In some implementations, data representing a second user of the second electronic device (e.g., an avatar) may also be received. For example, the portal content data 1136 may further include a representation of user 102 of device 105 or device 110 that was generated based on sensor data (e.g., sensor data 1102). In some implementations, the data representing the second 3D environment may include various types of 3D representations that may include, but is not limited to, a 180° or 360° stereo image (e.g., spherical maps, equirectangular projections, etc.), a 2D image and depth data/height map, or a 3D model/mesh. In some implementations, the data representing the second 3D environment may be received from a sender during or prior to a communication session. In some implementations, the data representing the second 3D environment may be based on outward facing sensors on the second device/HMD and/or hallucinated content.

In some implementations, the data representing the second 3D environment depicts a 360-degree view of the second 3D environment. In some implementations, the data representing the second 3D environment depicts less than a 360-degree view of the second 3D environment (e.g., 180-degree fOV).

In some implementations, the data representing the second 3D environment includes a stereoscopic image pair including left eye content corresponding to a left eye viewpoint and right eye content corresponding to a right eye viewpoint. For example, the data representing the second 3D environment may include a 180-degree stereo image, and/or spherical maps or equirectangular projections. Additionally, or alternatively, in some implementations, the data representing the second 3D environment includes two-dimensional (2D) image data and depth data (e.g., a 2D image and depth data/height map). In some implementations, the data representing the second 3D environment includes a 3D model (e.g., a 3D mesh representing the background environment).

In some implementations, the data representing the second 3D environment is obtained during a communication session between the first electronic device and a second electronic device. For example, as illustrated in FIG. 6, electronic devices 105 and 305 are operating in different physical environments 100 and 300, respectively, during a communication session, e.g., while the electronic devices 105, 305 are sharing information with one another or an intermediary device such as a communication session server.

At block 1230, the method 1200 determines portal content based on the data representing the second 3D environment and a viewpoint within the first 3D environment (e.g., a viewer's viewpoint of the portal). For example, as illustrated in FIGS. 7-10, the device 305 of user 302 (e.g., a viewer's device), determines the portal content 485 to be displayed with the portal 480.

In some implementations, the portal content is based on synthesizing data representing a portion of the second 3D environment not represented in sensor data captured in the physical environment of the second electronic device. For example, during capture of the sender's background, the sender's device may update a low frequency screenshot (e.g., an RGB image) and a depth map (and maybe some metadata such as head orientation/pose) during a communication session. Additionally, the viewer's device may be able to fill holes (e.g., update an incomplete map via an auto filling neural network) and update the background data. In some implementations, the viewer's device (e.g., device 305) may update the portal content using updating criteria based on viewpoint changes of the user, new content, the sender changing his or her position, new/different background views, detection of objects in motion, and the like.

In some implementations, the portal content is updated based on detecting a change in the second 3D environment or in the physical environment of the second electronic device. For example, the background of the portal content 485 may be updated based on the sender's device or the viewing device detecting new content in the background of the data representing the second 3D environment, the sender or viewer changing his or her position, new/different background views, and the like. In some implementations, determining portal content includes rendering at least a portion of the data representing the second 3D environment on at least a portion of a sphere.

At block 1240, the method 1200 displays a portal with the portal content in the view of the first 3D environment, where the portal content depicts a portion of the second 3D environment viewed through the portal from the viewpoint. For example, as illustrated in FIGS. 7-10, the device 305 of user 302 (e.g., a viewer's device), displays the portal content 485 within a view of the portal 480.

In some implementations, obtaining the data representing the second 3D environment includes obtaining a parameter associated with the data representing the second 3D environment. In some implementations, the parameter identifies a field of view or an orientation of the second 3D environment, and wherein determining portal content is further based on the parameter. For example, the system may update the background data based on viewpoint changes of the viewer, as illustrated in the different viewpoint scenarios of FIGS. 7-10.

In some implementations, determining portal content includes blurring some of the portion of the second 3D environment based on the identified field of view or the orientation of the second 3D environment. For example, a privacy blur may be applied to a portion of the background data (e.g., blocking any personal identifying information, such as a picture or photograph of a person or family member). For example, as illustrated in FIG. 7D, the representation 734 of the wall hanging 150 has been filtered (e.g., the frame of the representation 734 of the wall hanging 150 in FIG. 7D remains, but the content within the frame has been blocked from the view of the portal content 485).

In some implementations, the method 1200 further includes obtaining data representing a user of the second electronic device, wherein determining the portal content is further based on the data representing the user of the second electronic device, and wherein the portal content depicts the representation of the user of the second electronic device in front of the portion of the second 3D environment (e.g., displaying an avatar with the background). In some implementations, determining portal content includes blurring the portion of the second 3D environment behind the representation of the user of the second electronic device (e.g., applying a slight blur to the entire background behind the avatar).

In some implementations, the method 1200 further includes determining a position at which to display the portal within the view of the first 3D environment based on the viewpoint. In some implementations, the method 1200 further includes changing the portal content based on changes to the viewpoint within the first 3D environment. For example, as illustrated in FIGS. 7-10, as the user (e.g., viewer) moves his or her viewpoint, the view of the sender's environment background and avatar changes such that a viewer can look around 180° of the stereo image portal. The sender's avatar may continue to look forward, but the viewer can somewhat explore the limited portal content view of 180° stereo image.

In some implementations, displaying, in the view of the first 3D environment, the portal with the portal content is based on determining a positional relationship (e.g., distance, orientation, etc.) of the viewpoint (viewer's head or device) relative to the portal. For example, the positional relationship may be within or outside of a threshold distance from the visual content, within a sphere determined based on the visual content, and the like.

In some implementations, a position of the portal within the first 3D environment is constant as the viewpoint changes within the first 3D environment. For example, as the user (e.g., a viewer, such as user 302) moves around his or her environment (e.g., physical environment 300), the portal 480 stays in a fixed position (e.g., at the same 3D location). Alternatively, in some implementations, a position of the portal within the first 3D environment changes based on changes to the viewpoint within the first 3D environment. For example, as the user (e.g., a viewer, such as user 302) moves around his or her environment (e.g., physical environment 300), the portal 480 may move with the user. For example, the portal may appear to remain at the same viewing distance in front of the user 302, or the portal 480 may remain in same 3D location, but pivot so that it is always facing the user based on the user's viewpoint. Alternatively, in some implementations, the portal may move based on other changes in the environment such as in interruption event (e.g., another person or other object occluding the view of the portal 480).

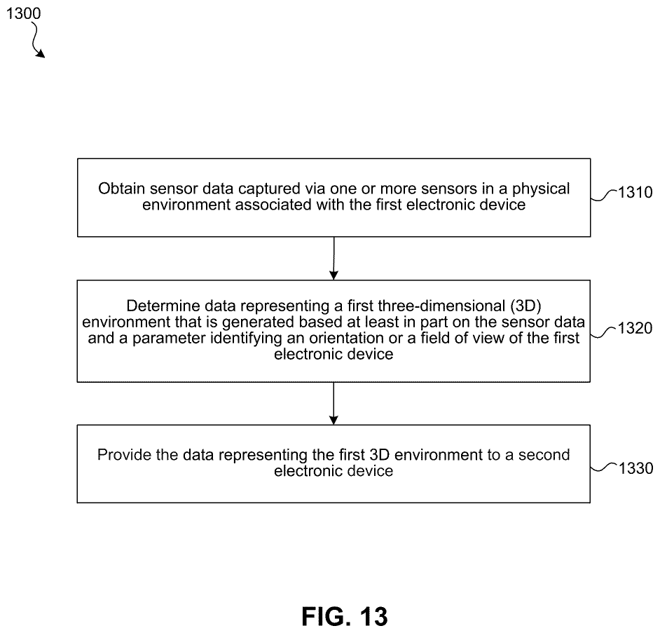

FIG. 13 is a flowchart illustrating a method 1300 for generating and providing a representation of a first 3D environment, in accordance with some implementations. In some implementations, a device such as electronic device 105, 110, 305, etc., performs method 1300. In some implementations, method 1300 is performed on a mobile device (e.g., device 110), desktop, laptop, HMD (e.g., device 105, 305), or server device. The method 1300 is performed by processing logic, including hardware, firmware, software, or a combination thereof. In some implementations, the method 1300 is performed on a processor executing code stored in a non-transitory computer-readable medium (e.g., a memory). In some implementations, the device performing the method 1300 includes a processor and one or more sensors.

In an exemplary implementation, the method 1300 is performed at a first electronic device having a processor and one or more sensors (e.g., outward facing sensors on the device, such as an HMD). In particular, the following blocks are performed at a sender's device (e.g., an HMD), such as device 105, and provides a sender-side perspective of the process of method 1200. For example, method 1200 provides views of a user's (e.g., sender's) environment to be viewed within a portal within views of a 3D environment (e.g., viewer's room). The portal may provide a multi-directional view (e.g., viewpoint dependent) of the sender's environment that changes as the sender changes position within his or her environment or the viewer moves relative to the portal. The data representing the user's 3D environment is provided by the user's device capturing sensor data of the user's environment, potentially filling data gaps/hallucinating content, and may be provided to the viewer's device using parameters (e.g., blurring, not depicting other people, providing a limited (e.g., 180° FOV), using updating criteria based on changes/new content, etc.). During capture of the sender's environment, the sender's device may update a low frequency screenshot (RGB image)+depth map (and metadata such as head orientation/pose), fill holes, and periodically provide updates to the viewer.

At block 1310, the method 1300 obtains sensor data captured via the one or more sensors in a physical environment associated with the first electronic device The sensor data 1102 may include image data, depth data, positional information, and the like. For example, sensors on a device (e.g., camera's, IMU, etc. on device 105 or device 110) can capture information about the position, location, motion, pose, etc., of the head and/or body of a user and the environment.

At block 1320, the method 1300 determines data representing a first 3D environment that is generated based at least in part on the sensor data and a parameter identifying an orientation or a field of view of the first electronic device. For example, as illustrated in FIG. 11, a viewing device, (e.g., device 105 or device 110) located in the physical environment 100 (e.g., a first environment), may obtain sensor data (e.g., sensor data 1102) of the first environment (e.g., physical environment 100 via device 110 or device 105 from a room scan). In some implementations, the data representing the first 3D environment may be generated and/or updated based on a parameter identifying the orientation or field of view that is based on pose of the first electronic device so that a second electronic device (e.g., a viewer's device) can render an appropriate portion of the environment in the within portal.

In some implementations, data representing a first user of the first electronic device (e.g., an avatar) may also be obtained. In some implementations, the data representing the first 3D environment may include various types of 3D representations that may include, but is not limited to, a 180° or 360° stereo image (e.g., spherical maps, equirectangular projections, etc.), a 2D image and depth data/height map, or a 3D model/mesh. In some implementations, the data representing the first 3D environment may be based on outward facing sensors on the first device/HMD and/or hallucinated content.

At block 1330, the method 1300 provides the data representing the first 3D environment to a second electronic device.

In some implementations, the data representing the first 3D environment is based on synthesizing data representing a portion of the first 3D environment not represented in sensor data captured in the physical environment of the first electronic device. For example, during capture of the sender's environment, the sender's device (e.g., device 105) may update a low frequency screenshot (e.g., an RGB image) and a depth map (and maybe some metadata such as head orientation/pose) during a communication session. Additionally, the sender's device may fill holes (e.g., update an incomplete map via an auto filling neural network) and update the data representing the first 3D environment. In some implementations, the sender's device may update the data representing the first 3D environment using updating criteria based on viewpoint changes of the user, new content, the sender changing his or her position, new/different background views, detection of objects in motion, and the like. In some implementations, the synthesized data is determined based on detecting a change in the viewpoint within the second 3D environment (e.g., hallucinating data based on viewpoint changes of the viewer). In some implementations, the synthesized data is determined based on identifying another portion of the first 3D environment that is not captured by the sensor data (e.g., hallucinating data based on detecting new background not obtained by the sensor data).

In some implementations, the portal content is updated based on detecting a change in the first 3D environment or in the physical environment of the second electronic device. For example, the data representing the first 3D environment may be updated based on the sender's device detecting new content in the environment, the sender or viewer changing his or her position, new/different background views, and the like. In some implementations, the data representing the first 3D environment is updated based on detecting a change in the physical environment of the first electronic device. For example, the sender's device may update the data representing the first 3D environment based on new content in the environment, the sender changing his or her position, new/different background views, and the like.

In some implementations, the data representing the first 3D environment is updated based on detecting that a change in a position of the first electronic device exceeds a threshold. For example, the sender's device may update the data representing the first 3D environment (and avatar) in response to the sender's electronic device moving a threshold distance (e.g., moving more than three to five meters, or another configurable threshold distance set by the system and/or the user).

In some implementations, the method 1300 further includes determining, based on the data representing the first 3D environment, a first lighting condition associated with an area of the first 3D environment, and updating the data representing the first 3D environment for the area associated with the first lighting condition in the first 3D environment. For example, as illustrated in FIG. 9, the system may detect bad lighting portions of the representation (e.g., blown out light sources and/or poor lighting conditions such as the light source anomaly 932 in FIG. 9C), and either replace the data with synthetic data (e.g., fake ceiling, wall color, etc.), or update the area of the first 3D environment based on a tone-map, or the like.

In some implementations, determining the data representing the first 3D environment includes determining a coverage of a background associated with the physical environment of the first electronic device based on the sensor data, and in response to determining that the coverage of the background captured of the physical environment is below a threshold amount, including synthesized background data for the portion of the first 3D environment in the data representing the first 3D environment. For example, the system may be configured to transmit a default background if coverage of the representation is below some threshold amount (e.g., if the room scan covers less than 50% of the current location and current viewpoint of the sender in the physical environment, then the system could display a default background as opposed to hallucinating content to fill in the gaps).

In some implementations, a blurring effect is applied by the first electronic device (e.g., the sender's device, device 105) to at least a portion of the data representing the first 3D environment provided to the second electronic device (e.g., the viewer's device, device 305). For example, the sender may apply a slight blur to the entire representation of the first 3D environment (e.g., in case the blurring is performed by the sender rather than the receiver/viewer).

In some implementations, the second electronic device is configured to display a view of the data representing the first 3D environment within a portal within a view of a second 3D environment (e.g., VR or XR). In some implementations, the first electronic device and the second electronic device are operatively communicating during a communication session. For example, as illustrated in FIG. 6, electronic devices 105 and 305 are operating in different physical environments 100 and 300, respectively, during a communication session, e.g., while the electronic device 105 (e.g., the sender's device) and electronic device 305 (e.g., the viewer's device) are sharing information with one another or an intermediary device such as a communication session server.

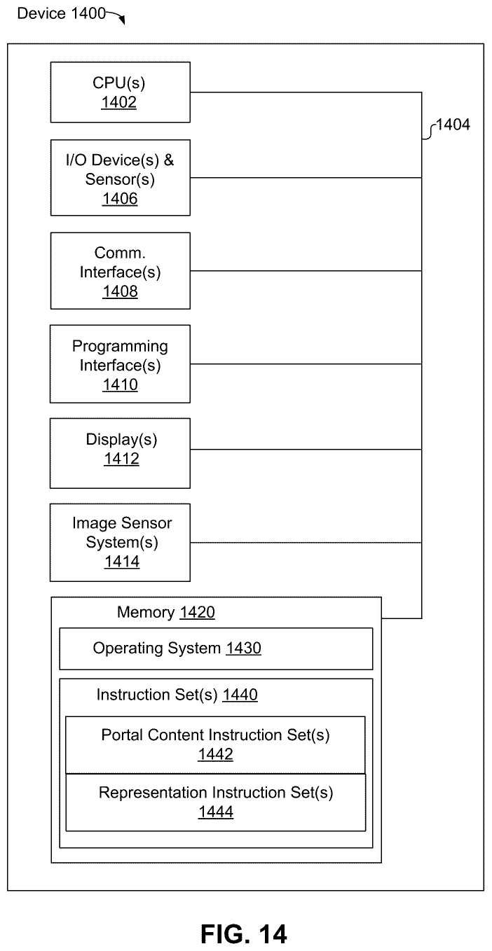

FIG. 14 is a block diagram of an example device 1400. Device 1400 illustrates an exemplary device configuration for devices described herein (e.g., device 105, device 110, device 305, etc.). While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 1400 includes one or more processing units 1402 (e.g., microprocessors, ASICs, FPGAs, GPUs, CPUs, processing cores, and/or the like), one or more input/output (I/O) devices and sensors 1406, one or more communication interfaces 1408 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, I2C, and/or the like type interface), one or more programming (e.g., I/O) interfaces 1410, one or more displays 1412, one or more interior and/or exterior facing image sensor systems 1414, a memory 1420, and one or more communication buses 1404 for interconnecting these and various other components.

In some implementations, the one or more communication buses 1404 include circuitry that interconnects and controls communications between system components. In some implementations, the one or more I/O devices and sensors 1406 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more displays 1412 are configured to present a view of a physical environment or a graphical environment to the user. In some implementations, the one or more displays 1412 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays 1412 correspond to diffractive, reflective, polarized, holographic, etc. waveguide displays. In one example, the device 10 includes a single display. In another example, the device 10 includes a display for each eye of the user.

In some implementations, the one or more image sensor systems 1414 are configured to obtain image data that corresponds to at least a portion of the physical environment 105. For example, the one or more image sensor systems 1414 include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 1414 further include illumination sources that emit light, such as a flash. In various implementations, the one or more image sensor systems 1414 further include an on-camera image signal processor (ISP) configured to execute a plurality of processing operations on the image data.

The memory 1420 includes high-speed random-access memory, such as DRAM, SRAM, DDR RAM, or other random-access solid-state memory devices. In some implementations, the memory 1420 includes non-volatile memory, such as one or more magnetic disk storage devices, optical disk storage devices, flash memory devices, or other non-volatile solid-state storage devices. The memory 1420 optionally includes one or more storage devices remotely located from the one or more processing units 1402. The memory 1420 includes a non-transitory computer readable storage medium.

In some implementations, the memory 1420 or the non-transitory computer readable storage medium of the memory 1420 stores an optional operating system 1430 and one or more instruction set(s) 1440. The operating system 1430 includes procedures for handling various basic system services and for performing hardware dependent tasks. In some implementations, the instruction set(s) 1440 include executable software defined by binary information stored in the form of electrical charge. In some implementations, the instruction set(s) 1440 are software that is executable by the one or more processing units 1302 to carry out one or more of the techniques described herein.

The instruction set(s) 1440 includes a portal content instruction set 1442 to generate portal content data, and a representation instruction set 1444 generate and display representations of a background and/or a user. The instruction set(s) 1440 may be embodied a single software executable or multiple software executables. In some implementations, the portal content instruction set 1442 and the representation instruction set 1444 are executable by the processing unit(s) 1402 using one or more of the techniques discussed herein or as otherwise may be appropriate. To these ends, in various implementations, the instruction includes instructions and/or logic therefor, and heuristics and metadata therefor.

Although the instruction set(s) 1440 are shown as residing on a single device, it should be understood that in other implementations, any combination of the elements may be located in separate computing devices. Moreover, FIG. 14 is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

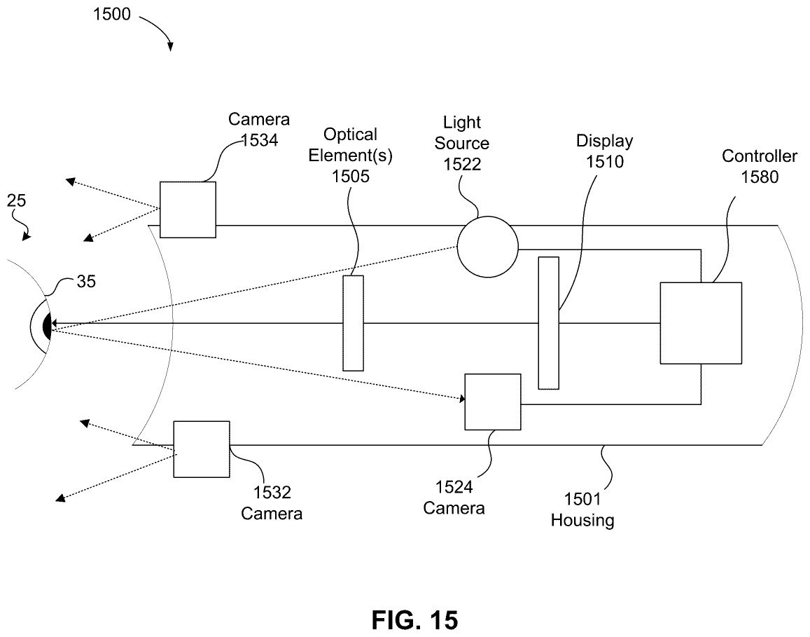

FIG. 15 illustrates a block diagram of an exemplary head-mounted device 1500 in accordance with some implementations. The head-mounted device 1500 includes a housing 1501 (or enclosure) that houses various components of the head-mounted device 1500. The housing 1501 includes (or is coupled to) an eye pad (not shown) disposed at a proximal (to the user 25) end of the housing 1501. In various implementations, the eye pad is a plastic or rubber piece that comfortably and snugly keeps the head-mounted device 1500 in the proper position on the face of the user 25 (e.g., surrounding the eye 35 of the user 25).

The housing 1501 houses a display 1510 that displays an image, emitting light towards or onto the eye 35 of a user 25. In various implementations, the display 1510 emits the light through an eyepiece having one or more optical elements 1505 that refracts the light emitted by the display 1510, making the display appear to the user 25 to be at a virtual distance farther than the actual distance from the eye to the display 1510. For example, optical element(s) 1505 may include one or more lenses, a waveguide, other diffraction optical elements (DOE), and the like. For the user 25 to be able to focus on the display 1510, in various implementations, the virtual distance is at least greater than a minimum focal distance of the eye (e.g., 7 cm). Further, in order to provide a better user experience, in various implementations, the virtual distance is greater than 1 meter.

The housing 1501 also houses a tracking system including one or more light sources 1522, camera 1524, camera 1532, camera 1534, and a controller 1580. The one or more light sources 1522 emit light onto the eye of the user 25 that reflects as a light pattern (e.g., a circle of glints) that can be detected by the camera 1524. Based on the light pattern, the controller 1580 can determine an eye tracking characteristic of the user 25. For example, the controller 1580 can determine a gaze direction and/or a blinking state (eyes open or eyes closed) of the user 25. As another example, the controller 1580 can determine a pupil center, a pupil size, or a point of regard. Thus, in various implementations, the light is emitted by the one or more light sources 1522, reflects off the eye of the user 25, and is detected by the camera 1524. In various implementations, the light from the eye of the user 25 is reflected off a hot mirror or passed through an eyepiece before reaching the camera 1524.

The display 1510 emits light in a first wavelength range and the one or more light sources 1522 emit light in a second wavelength range. Similarly, the camera 1524 detects light in the second wavelength range. In various implementations, the first wavelength range is a visible wavelength range (e.g., a wavelength range within the visible spectrum of approximately 400-700 nm) and the second wavelength range is a near-infrared wavelength range (e.g., a wavelength range within the near-infrared spectrum of approximately 700-1400 nm).

In various implementations, eye tracking (or, in particular, a determined gaze direction) is used to enable user interaction (e.g., the user 25 selects an option on the display 1510 by looking at it), provide foveated rendering (e.g., present a higher resolution in an area of the display 1510 the user 25 is looking at and a lower resolution elsewhere on the display 1510), or correct distortions (e.g., for images to be provided on the display 1510). In various implementations, the one or more light sources 1522 emit light towards the eye of the user 25 which reflects in the form of a plurality of glints.

In various implementations, the camera 1524 is a frame/shutter-based camera that, at a particular point in time or multiple points in time at a frame rate, generates an image of the eye of the user 25. Each image includes a matrix of pixel values corresponding to pixels of the image which correspond to locations of a matrix of light sensors of the camera. In implementations, each image is used to measure or track pupil dilation by measuring a change of the pixel intensities associated with one or both of a user's pupils.

In various implementations, the camera 1524 is an event camera including a plurality of light sensors (e.g., a matrix of light sensors) at a plurality of respective locations that, in response to a particular light sensor detecting a change in intensity of light, generates an event message indicating a particular location of the particular light sensor.

In various implementations, the camera 1532 and camera 1534 are frame/shutter-based cameras that, at a particular point in time or multiple points in time at a frame rate, can generate an image of the face of the user 25. For example, camera 1532 captures images of the user's face below the eyes, and camera 1534 captures images of the user's face above the eyes. The images captured by camera 1532 and camera 1534 may include light intensity images (e.g., RGB) and/or depth image data (e.g., Time-of-Flight, infrared, etc.).

It will be appreciated that the implementations described above are cited by way of example, and that the present invention is not limited to what has been particularly shown and described hereinabove. Rather, the scope includes both combinations and sub combinations of the various features described hereinabove, as well as variations and modifications thereof which would occur to persons skilled in the art upon reading the foregoing description and which are not disclosed in the prior art.

As described above, one aspect of the present technology is the gathering and use of sensor data that may include user data to improve a user's experience of an electronic device. The present disclosure contemplates that in some instances, this gathered data may include personal information data that uniquely identifies a specific person or can be used to identify interests, traits, or tendencies of a specific person. Such personal information data can include movement data, physiological data, demographic data, location-based data, telephone numbers, email addresses, home addresses, device characteristics of personal devices, or any other personal information.

The present disclosure recognizes that the use of such personal information data, in the present technology, can be used to the benefit of users. For example, the personal information data can be used to improve the content viewing experience. Accordingly, use of such personal information data may enable calculated control of the electronic device. Further, other uses for personal information data that benefit the user are also contemplated by the present disclosure.

The present disclosure further contemplates that the entities responsible for the collection, analysis, disclosure, transfer, storage, or other use of such personal information and/or physiological data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates implementations in which users selectively block the use of, or access to, personal information data. That is, the present disclosure contemplates that hardware or software elements can be provided to prevent or block access to such personal information data. For example, in the case of user-tailored content delivery services, the present technology can be configured to allow users to select to “opt in” or “opt out” of participation in the collection of personal information data during registration for services. In another example, users can select not to provide personal information data for targeted content delivery services. In yet another example, users can select to not provide personal information, but permit the transfer of anonymous information for the purpose of improving the functioning of the device.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences or settings based on non-personal information data or a bare minimum amount of personal information, such as the content being requested by the device associated with a user, other non-personal information available to the content delivery services, or publicly available information.

In some embodiments, data is stored using a public/private key system that only allows the owner of the data to decrypt the stored data. In some other implementations, the data may be stored anonymously (e.g., without identifying and/or personal information about the user, such as a legal name, username, time and location data, or the like). In this way, other users, hackers, or third parties cannot determine the identity of the user associated with the stored data. In some implementations, a user may access their stored data from a user device that is different than the one used to upload the stored data. In these instances, the user may be required to provide login credentials to access their stored data.

Numerous specific details are set forth herein to provide a thorough understanding of the claimed subject matter. However, those skilled in the art will understand that the claimed subject matter may be practiced without these specific details. In other instances, methods apparatuses, or systems that would be known by one of ordinary skill have not been described in detail so as not to obscure claimed subject matter.

Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description and summary of the invention are to be understood as being in every respect illustrative and exemplary, but not restrictive, and the scope of the invention disclosed herein is not to be determined only from the detailed description of illustrative implementations but according to the full breadth permitted by patent laws. It is to be understood that the implementations shown and described herein are only illustrative of the principles of the present invention and that various modification may be implemented by those skilled in the art without departing from the scope and spirit of the invention.

What is claimed is:

1. A method comprising:
at a first electronic device having a processor:
presenting a view of a first three-dimensional (3D) environment;
obtaining data representing a second 3D environment, the data representing the second 3D environment based at least in part on sensor data captured in a physical environment of a second electronic device;
determining portal content based on the data representing the second 3D environment and a viewpoint within the first 3D environment; and
displaying, in the view of the first 3D environment, a portal with the portal content, wherein the portal content depicts a portion of the second 3D environment viewed through the portal from the viewpoint.

2. The method of claim 1, wherein the portal content is based on synthesizing data representing a portion of the second 3D environment not represented in sensor data captured in the physical environment of the second electronic device.

3. The method of claim 1, wherein the portal content is updated based on detecting a change in the second 3D environment or in the physical environment of the second electronic device.

4. The method of claim 1, wherein obtaining the data representing the second 3D environment comprises obtaining a parameter associated with the data representing the second 3D environment.

5. The method of claim 4, wherein the parameter identifies a field of view or an orientation of the second 3D environment, and wherein determining portal content is further based on the parameter.

6. The method of claim 5, wherein determining portal content comprises blurring some of the portion of the second 3D environment based on the identified field of view or the orientation of the second 3D environment.

7. The method of claim 1, further comprising obtaining data representing a user of the second electronic device, wherein determining the portal content is further based on the data representing the user of the second electronic device, and wherein the portal content depicts the representation of the user of the second electronic device in front of the portion of the second 3D environment.

8. The method of claim 7, wherein determining portal content comprises blurring the portion of the second 3D environment behind the representation of the user of the second electronic device.

9. The method of claim 1, wherein the data representing the second 3D environment depicts less than a 360-degree view of the second 3D environment.

10. The method of claim 1, wherein the data representing the second 3D environment depicts a 360-degree view of the second 3D environment.

11. The method of claim 1, further comprising:
determining a position at which to display the portal within the view of the first 3D environment based on the viewpoint.

12. The method of claim 1, further comprising:
changing the portal content based on changes to the viewpoint within the first 3D environment.

13. The method of claim 1, wherein displaying, in the view of the first 3D environment, the portal with the portal content is based on determining a positional relationship of the viewpoint relative to the portal.

14. The method of claim 1, wherein a position of the portal within the first 3D environment is constant as the viewpoint changes within the first 3D environment.

15. The method of claim 1, wherein a position of the portal within the first 3D environment changes based on changes to the viewpoint within the first 3D environment.

16. The method of claim 1, wherein the data representing the second 3D environment comprises a stereoscopic image pair comprising left eye content corresponding to a left eye viewpoint and right eye content corresponding to a right eye viewpoint.

17. The method of claim 1, wherein the data representing the second 3D environment comprises a 180-degree stereo image.

18. The method of claim 1, wherein the data representing the second 3D environment comprises two-dimensional (2D) image data and depth data.

19. The method of claim 1, wherein determining portal content comprises rendering at least a portion of the data representing the second 3D environment on at least a portion of a sphere.

20. The method of claim 1, wherein the data representing the second 3D environment comprises a three-dimensional (3D) model.

21. The method of claim 1, wherein the data representing the second 3D environment is obtained during a communication session between the first electronic device and a second electronic device.

22. The method of claim 1, wherein the sensor data captured in the physical environment of the second electronic device is obtained by one or more sensors of the second electronic device.

23. The method of claim 1, wherein the first 3D environment is an extended reality (XR) environment.

24. A device comprising:
a non-transitory computer-readable storage medium; and
one or more processors coupled to the non-transitory computer-readable storage medium, wherein the non-transitory computer-readable storage medium comprises program instructions that, when executed on the one or more processors, cause the one or more processors to perform operations comprising:
presenting a view of a first three-dimensional (3D) environment;
obtaining data representing a second 3D environment, the data representing the second 3D environment based at least in part on sensor data captured in a physical environment of a second electronic device;
determining portal content based on the data representing the second 3D environment and a viewpoint within the first 3D environment; and
displaying, in the view of the first 3D environment, a portal with the portal content, wherein the portal content depicts a portion of the second 3D environment viewed through the portal from the viewpoint.

25. A non-transitory computer-readable storage medium, storing program instructions executable on a device to perform operations comprising:
presenting a view of a first three-dimensional (3D) environment;
obtaining data representing a second 3D environment, the data representing the second 3D environment based at least in part on sensor data captured in a physical environment of a second electronic device;
determining portal content based on the data representing the second 3D environment and a viewpoint within the first 3D environment; and
displaying, in the view of the first 3D environment, a portal with the portal content, wherein the portal content depicts a portion of the second 3D environment viewed through the portal from the viewpoint.
